(19) United States
(12) Patent Application Publication
(10) Pub. No.: US 2013/0262568 A1
(43) Pub. Date: Oct. 3, 2013

(54) CONTENT MANAGEMENT SYSTEM FOR PUBLISHING GUIDES

(71) Applicant: HEAVY BITS, INC., San Francisco, CA (US)

(72) Inventors: Daniel Raffel, San Francisco, CA (US); Steve Krulewitz, San Francisco, CA (US); Rahul Malik, San Francisco, CA (US)

(21) Appl. No.: 13/844,194

(22) Filed: Mar. 15, 2013

Related U.S. Application Data
(60) Provisional application No. 61/616,705, filed on Mar. 28, 2012.

(51) Int. Cl. H04L 29/08

(52) U.S. Cl. CPC H04L 67/10
USPC 709/203

(57) ABSTRACT

Technology for a content management system for publishing how-to guides is disclosed herein. In some embodiments, a method for publishing how-to guides includes importing a plurality of multimedia items into a first processing device; specifying, at the first processing device, a plurality of steps of a multimedia instructional presentation by inputting narrative in association with the multimedia items; and causing the multimedia instructional presentation to be published onto an electronic medium.

This application claims the benefit of U.S. Provisional Patent Application No. 61/616,705, entitled “CONTENT MANAGEMENT SYSTEM FOR PUBLISHING GUIDES”, which was filed on Mar. 28, 2012, which is incorporated by reference herein in its entirety.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever.

### BACKGROUND

Creating and electronically publishing (e.g., on the Internet) a story, blog post, or instructional “how-to” guide that contains a series of images, photos, videos and text can be quite challenging to many people. Part of the reason this process can be challenging is that conventionally, it involves first connecting a camera to a computer to import images, then uploading the images using a web browser, and then typing the story or narrative into a website by hand. Hence, multiple devices and services need to be connected together in order to create the how-to guide.

It is particularly challenging for an average person to figure out how to upload multimedia content to the Internet and to make the content viewable in a format that is suitable for presentation on various devices, such as personal computers, mobile devices and tablet devices.

### SUMMARY

Techniques introduced here provide a content management system for publishing content such as multimedia instructional (“how-to”) guides (also referred to as multimedia instructional presentations) containing photos, videos and text for a project that a user is working on in realtime. The guide can be, for example, a recipe for cooking, instructions for fixing or repairing something, a tutorial for building an original product, or any other type of how-to guide. The content management system makes it easy for people to share instructional knowledge with one another using popular devices (e.g. mobile phones) with Internet connections.

The content management system allows people using mobile devices to create and consume multimedia how-to content containing step-by-step instructions. A series of interface flows of the content management system form an intuitive experience for a user to create such a guide.

Every operation of creating and editing the how-to guide is synchronized with a centralized content management server. The media, including images and videos, are synchronized as well. Since all information about the guide is synchronized to the centralized content management server, a user can start creating a guide on one device and later switch to another device to continue creating the same guide.

When a user is creating or modifying a guide using a device that is not currently connected to the Internet, the changes are first stored locally on the device. The changes will be uploaded to the centralized server when the device is connected to the Internet. The centralized server merges the changes with the previously stored information of the guide on the server to reflect the latest state of the guide.

Other aspects of the technology introduced here will be apparent from the accompanying figures and from the detailed description which follows.

### BRIEF DESCRIPTION OF THE DRAWINGS

These and other objects, features and characteristics of the present invention will become more apparent to those skilled in the art from a study of the following detailed description in conjunction with the appended claims and drawings, all of which form a part of this specification. In the drawings:

FIG. 1 is a high-level block diagram of an example of a computing environment in which the techniques introduced here can be implemented.

FIG. 2 illustrates an example of a mobile application for creating and publishing how-to guides in an interactive, online medium.

FIG. 3A illustrates an example of a computer-implemented process for using a mobile application to create and publish a how-to guide.

FIG. 3B illustrates an example of a main interface including tabs for various features of the mobile application.

FIG. 3C illustrates an example of a user profile interface.

FIG. 3D illustrates an example of a title interface for entering a tile for the guide.

FIG. 3E illustrates an example of a camera interface for capturing photos and videos.

FIG. 3F illustrates an example of an Editor interface for summarizing and editing the steps of the guide

FIG. 3G illustrates an example of an Edit Details interface for editing a step of the guide.

FIG. 3H illustrates an example of a supplies interface for entering information of supplies for the guide.

FIG. 3I illustrates an example of a publish interface for publishing a guide.

FIG. 4 illustrates an example of a computer-implemented process for an algorithm for creating and publishing how-to guides.

FIG. 5 is a high-level block diagram illustrating an example of the architecture of a processing system, which may any electronic device or server mentioned herein.

### DETAILED DESCRIPTION

References in this specification to “an embodiment,” “one embodiment,” or the like, mean that the particular feature, structure, or characteristic being described is included in at least one embodiment of the present invention. Occurrences of such phrases in this specification do not all necessarily refer to the same embodiment, nor are they necessarily mutually exclusive.

The content management system disclosed herein enables users to create and publish semantically highly structured step-by-step instructions including multimedia content. The system asks the user to provide a title for the project of the how-to guide. Then the system prompts the user to provide photos and captions that describe each step of the project. By guiding the user through a series of configured interaction flows, the system allows the user to provide the information for the steps by following a straightforward interface. The user needs no extra instruction to follow the intuitive interface. The system further has an editor interface that enables the user to edit the steps and the sequence ordering of the steps. The system also prompts the user to list the supplies (e.g. tools, materials, ingredients) that are necessary to perform the project.

In the editor interface, the system shows a high level summary of the guide by showing each step as a thumbnail icon. The editor interface enables the user to preview the sequence of the steps for the project. Each step represents a specific action that can be taken during the project. A step in the how-to guide can contain, for example, photo, video, and/or text. The system provides a drag-and-drop interface to allow the user to re-order the steps that the system has incorporated into the guide.

A centralized content management server synchronizes every operation of creating and editing the how-to guide. The system also supports offline mode. In offline mode, a user creates or modifies a guide using a device that is not currently connected to the Internet. In the background, the changes are first stored locally on the device, and are later uploaded to the centralized server when the device is connected to the Internet.

The system can handle errors including failures to upload media (e.g. uploading photos or videos). For instance, when the server does not receive a photo for a certain step, if the user switches to another device, the system can indicate to the other device that there is a missing image. The user has the option to replace the missing image with another image captured by or stored in the other device.

The centralized content management server can also enable multiple collaborative users to work on a single how-to guide simultaneously. The centralized server merges the changes from all the collaborative users and sends the updates of the guide to the devices of the collaborative users in real time.

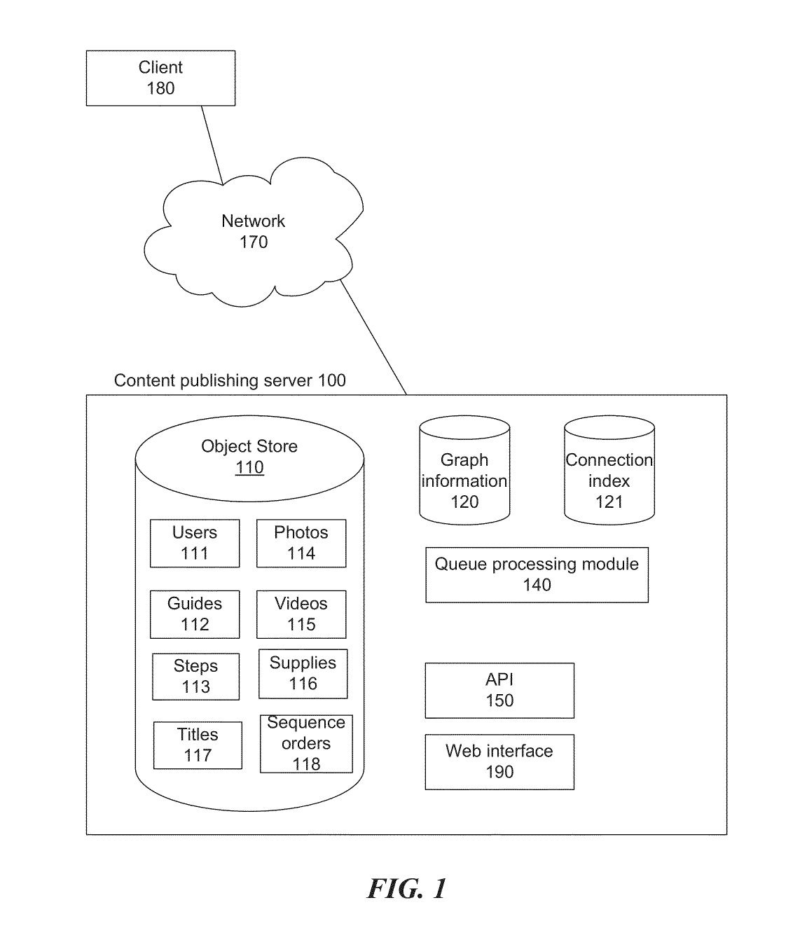

FIG. 1 is a high-level block diagram of a computing environment in which the technique introduced here can be implemented, according to one embodiment. As FIG. 1 shows, a content publishing server 100 and a mobile device 180 are connected by a network 170. A user of the mobile device 180 interacts with the content publishing server 100 via an application such as a mobile application. The application performs operations including posting pictures and descriptions, and setting sequences of the steps of a guide.

The content publishing server 100 comprises a number of components used to store information on objects of the guides, and on the relationships of the objects. The content publishing server 100 additionally comprises components to enable clients of the system (e.g. the mobile device 180) to communicate with the system.

More specifically, the content publishing server 100 comprises an object store 110 that stores information on various objects tracked by the content publishing server 100. These objects may represent a variety of things with which a user may interact in the content publishing server 100, including users 111 of the content publishing server (represented, e.g., as a profile object for the user), guides 112, steps of the guides 113, photos 114, video clips 115, or other items. The object store 110 can also include metadata for the guides 112, including supplies 116, titles 117, and sequence orders of the guides 118. The object store 110 may further store objects representing other data routinely produced by users of the content publishing server 100, such as inbox messages, comments, notes, and postings.

In one embodiment, the content publishing server 100 further comprises a graph information store 120 that stores a graph data structure that represents the objects of the object store 110 as nodes that are linked together in a guide. The graph information store 120 thus comprises information about the relationships between or among the objects, represented as the edges connecting the various object nodes. For example, the graph information store 120 can store information regarding the sequence ordering of all pictures in a guide. In another example, the graph information store 120 can store information regarding a picture and its description representing an alternative step in a guide.

In one embodiment, the content publishing server 100 adds information to the graph information store 120 in real time as it observes events taking place indicating relationships between the various objects, such as a user changing the ordering of the steps of the guide.

In one embodiment, the content publishing server comprises a connection index 121 that stores a subset of the information in the graph information store 120 in a manner that allows rapid queries of that information. For example, in one embodiment the connection index 121 stores, for each step, a list of all of the connections between that step and other steps. This allows, for example, a rapid determination the objects related to a particular step.

The content publishing server 100 further comprises a queue processing module 140. A user can perform various operations, including adding steps, editing steps, chancing sequence ordering of the steps, in a mobile application running on the mobile device 180. The mobile application records these operations in an operation queue and transfers the operation queue to the content publishing server 100. The queue processing module 140 is responsible for applying the operations to the instance of the guide stored in the content publishing server 100, so that a centralized copy of the guide is maintained in the content publishing server 100.

The content publishing server 100 further includes a web interface 190 that provides similar functionalities of the mobile application running on the mobile device 180. A user can make, edit, and publish a guide using a browser program connected with the web interface 190 in a similar way as using the mobile application running on the mobile device 180.

The content publishing server 100 can also provide the search functionality to its users to search a guide based on keywords. In other embodiments, however, the content publishing server 100 may export this search capability to third-party systems. For example, the content publishing server 100 may comprise an application programming interface (API) 150, as shown, that can be used to access information stored by the content publishing server, such as the various objects of the object store 110. In one embodiment, the API 150 can be accessed both locally and remotely. For example, the API 150 may be accessed via a locally-loaded module, such as a DLL, or it may be may be accessed remotely as a web service by a third party website 190 or other remote system.

The content publishing server 100 can include a single server computer, or multiple interconnected computer nodes (e.g., a cluster). The content publishing server 100 can include various computer nodes, wherein each computer node is responsible for performing one or more of the various functionalities as disclosed above.

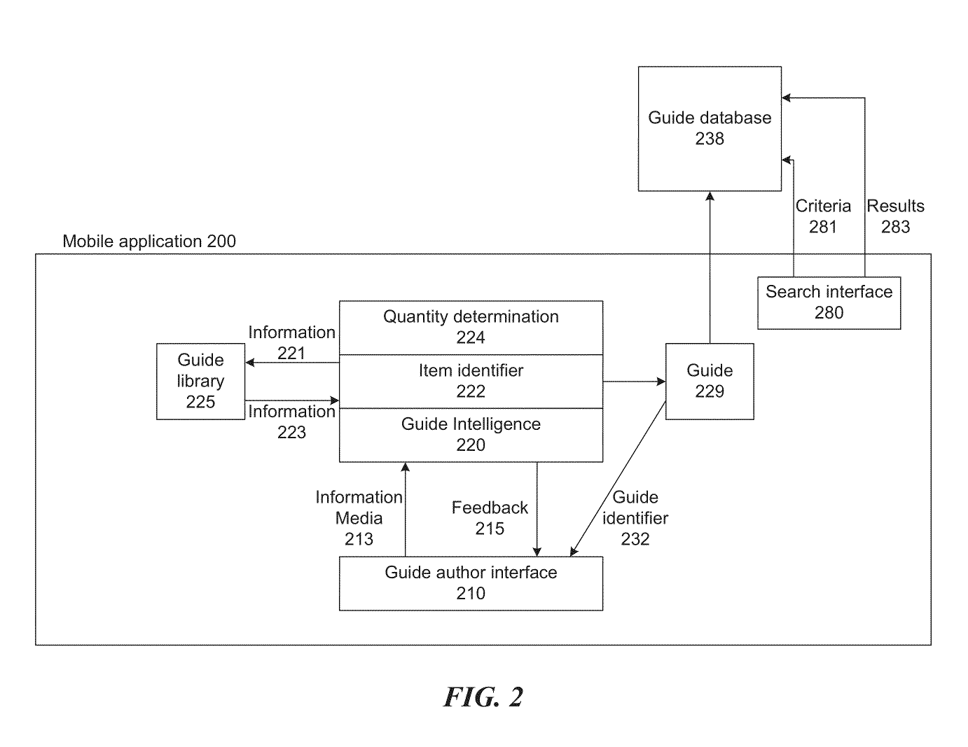

FIG. 2 illustrates a mobile application 200 for creating and publishing how-to guides in an interactive, online medium. The mobile application 200 can be designed to run on a mobile device (e.g. mobile device 180). The mobile application 200 enables a user to create and publish an interactive how-to guide in an online medium selected by the user, such as a social media website, a personal web blog, or an email message. A user may specify content of a how-to guide that includes media (e.g., images, video), as well as text entered in various forms (e.g., short sentence, list or paragraph form). Additionally, the mobile application 200 may enable users to locate existing how-to guides stored at web servers. Thus, users can utilize the mobile application 200 to search for how-to guides created by others.

Mobile application 200 can facilitate the user in creating a how-to guide by, for example, formatting the text or content provided by the user, supplementing the how-to guide with additional information, functionality and services, and/or making suggestions to the user regarding the information in the steps performed in the how-to guide. The mobile application 200 can generate a guide identifier 232 for identifying the how-to guide.

The mobile application 200 can be implemented as an application running on a mobile device (e.g. mobile device 180) or other computing device operated by a user. Alternatively, the mobile application 200 may be implemented as a service, provided through, for example, a web server that enables its users to create how-to guides, and to search and use how-to guides. As a web service, the mobile application 200 can be implemented as a service running on one or more servers.

The mobile application 200 includes modules that include a guide author interface 210 and a guide intelligence module 220. The guide author interface 210 includes functionality that provides the user (i.e. the author) with input fields, prompts, and other interactive mechanisms in order for the author to enter information 211 about his or her how-to guide. The information 211 provided by the author may include text, such as instructional text about the steps for performing the how-to guide. Information 211 provided by the author can also include media 213, including images, audio, and/or video as to how particular steps of the how-to guide are to be performed. In one embodiment, for instance, author interface 210 is implemented as a wizard, which can guide the user into entering information for the how-to guide, as well as collect information from the user about his or her preferences as to how the how-to guide is to appear.

The guide intelligence module 220 analyzes and/or responds to information 211 and/or media 213 provided from the user about a guide in order to provide feedback 215 via the interface 210 to the author about the guide. The feedback 215 can be provided responsively, such as in real-time while the author specifies information for the guide. The feedback 215 can further include, for example, formatted information provided by the user, augmented information/content for the guide, supplemental information (e.g., alternatives, suggestions), and augmented information.

The sub-components of guide intelligence module 220 include an item identifier 222 and a quantity determination module 224. In one embodiment, the guide intelligence module 220 utilizes the programming logic of the item identifier to parse and/or analyze the user's text in order to identify words that correspond to items (e.g. tools or ingredients) to be used in the steps of the how-to guide. In another embodiment, the guide interface 210 designates specific fields for user input as being item lists. For instance, the author may be presented with a field that prompts the author to list all the tools to be used in the project presented in the how-to guide.

Similarly, quantity determination module 224 identifies text or characters that correspond to a quantity of a particular item. Examples include fractions, words that are known to refer to quantities (e.g., cups, gallons, and square feet) or alphanumeric representations of numbers (e.g., ‘12’ or dozen). The guide author interface 210 displays designated fields in which the user can specify a quantity for an item (e.g. an ingredient). Alternatively, the guide author interface 210 may cause the user to specify which phrase in a how-to guide corresponds to a quantity. In this manner, the author is able to tag the portions of the how-to guide that correlate to quantity. The quantity determination module 224 may further recognize a quantity from an image or a video supplied by the author. For instance, the author takes a picture of four copper plumbing tubes in a picture. The quantity determination module 224 can automatically recognize that the project of the how-to guide needs four such tubes. The quantity determination module 224 can even recognize the required length of the tubes.

The guide intelligence module 220 is able to use an item list (set of items determined from the guide author's information) and corresponding quantity statements to facilitate the user's creation of the how to guide, supplement or augment the user's guide with additional information and/or suggestions (e.g. alternatives), and provide additional functionality in connection with an interactive how-to guide.

The guide intelligence module 220 can auto-complete the user's guide or guide steps. For example, in a popular category of projects, the last series of steps may be well known, and the guide intelligence module 220 can generate steps to present to the user as suggestions via the interface 210. Likewise, common steps may be auto-completed in a similar fashion.

The guide intelligence module 220 can access a repository of how-to guides to make suggestions or recommendations as to the specifics in the guide being created by the author. For instance, in one embodiment, guide intelligence module 220 compares specific information 221 of the guide being created to existing guides stored in a guide library 225 in order to identify relevant information for a particular guide. For example, the guide intelligence module 220 may be adapted to structure a query from information 221 in order to retrieve the information 223 from the guide library 225.

The information 221 can correspond to, for example, a product that is to be created from the how-to guide, or individual items specified by the author for the how-to guide. The relevant information 223 that can be retrieved from the guide library 225 can include, for example, items or instructions specified in other guides for the same or similar product. In some embodiments, the guide intelligence module 220 accesses other similar guides to identify specific items used. The guide intelligence module 220 may retrieve the specific information about the items as a basis for making a recommendation to the guide author. In this regard, the guide author may specify specific types of items, and the guide intelligence module 220 may suggest alternatives that have been used in other similar guides or are otherwise known for the particular category of projects.

In addition to making recommendations as to a particular type of items, the guide intelligence module 220 may also suggest alternatives to items or quantities specified by the user. Furthermore, links or information may be provided to the user as to resources to validate the suggestion being made. In some embodiments, the guide intelligence module 220 may also notify the user if the author's specifications are outside of the norm in a particular category of projects.

The guide intelligence module 220 may also determine when additional steps or items can be beneficial to the project of the how-to guide. For instance, the guide intelligence module 220 may specify when the use of a particular item, e.g. an electrical nail hammer instead of a regular hammer, that can help expedite the process of the project. Further, the guide intelligence module 220 may add or suggest alternative steps to the steps being provided by the author. For example, if the author specifies a particular time period for a type of glue to cure, the guide intelligence module 220 may access resources to suggest (e.g., from popular how-to guides on the field) that a even longer time period is needed to wait for that glue to cure.

The various feedback 215 provided from the guide intelligence module 220 (e.g., recommendations, suggestions, information provided by the guide intelligence module 220) can be based on other how-guides that the guide intelligence module 220 accesses. Guides that are used for comparison purposes can be evaluated on the basis of, for example, popularity (e.g., highly ranked guides are those that have been viewed or downloaded the most) or credibility (e.g., they are from authors who have credentials such as expertise in a particular field of projects).

By entering information 211, the author is able to create a how-to guide. The process by which the author enters information 211 and content 213 for a how-to guide can be interactive, educational and one that enables the user to express creativity. For example, the user can upload media 213 in the form of pictures and videos that are instructional as to performing steps specified in his or her how-to guide. Furthermore, the user may access other resources, such as videos of other persons performing certain steps, movie clips, etc., in order to create an interactive experience about his or her how-to guide. Such videos and images may be displayed in connection with specific steps of the user's guide. The specific steps that comprise the guide can also be selectable by a user in order to display additional information and content, such as media, paragraph descriptions and other information.

During and after the author creates a how-to guide 229, the guide can be stored in a guide database 238. The information stored in the guide database 238 can also include various information determined from a user's guide. This information can include, for example, suggestions, alternatives as determined by the guide intelligence module 220. The information stored in connection with the particular guide 229 may be determined at the time the guide 229 is created (e.g., presented to the author in real-time), or subsequent determined after the author has created the guide 229. The guide database 238 can be stored in a centralized server, e.g. the content publishing server 100.

The guide intelligence module 220 can take advances of the metadata of the photos to determine the sequence of the steps. For instance, when photos are captured, the metadata of the photos (e.g. Exchangeable image file format (Exif) data) can be used to determine the time points when the photos are taken. Accordingly, the guide intelligence module 220 can determine the sequence of the steps based on the time points information extracted from Exif data.

The mobile application 200 may provide a search interface 280. The guide database 238 may be coupled to the search interface 280 that enables users to search for how-to guides by specifying search criteria 281. The guide database 238 presents results 283. Users can use the search interface 280 to search for how-to guides based on similarities. For example, a user may seek how-to guides that have content similar to his/her own how-to guide. A user may locate an existing how-to guide of his/her own and then modify the guide by adding or substituting steps, and incorporating additional text to describe the steps of the how-to guide.

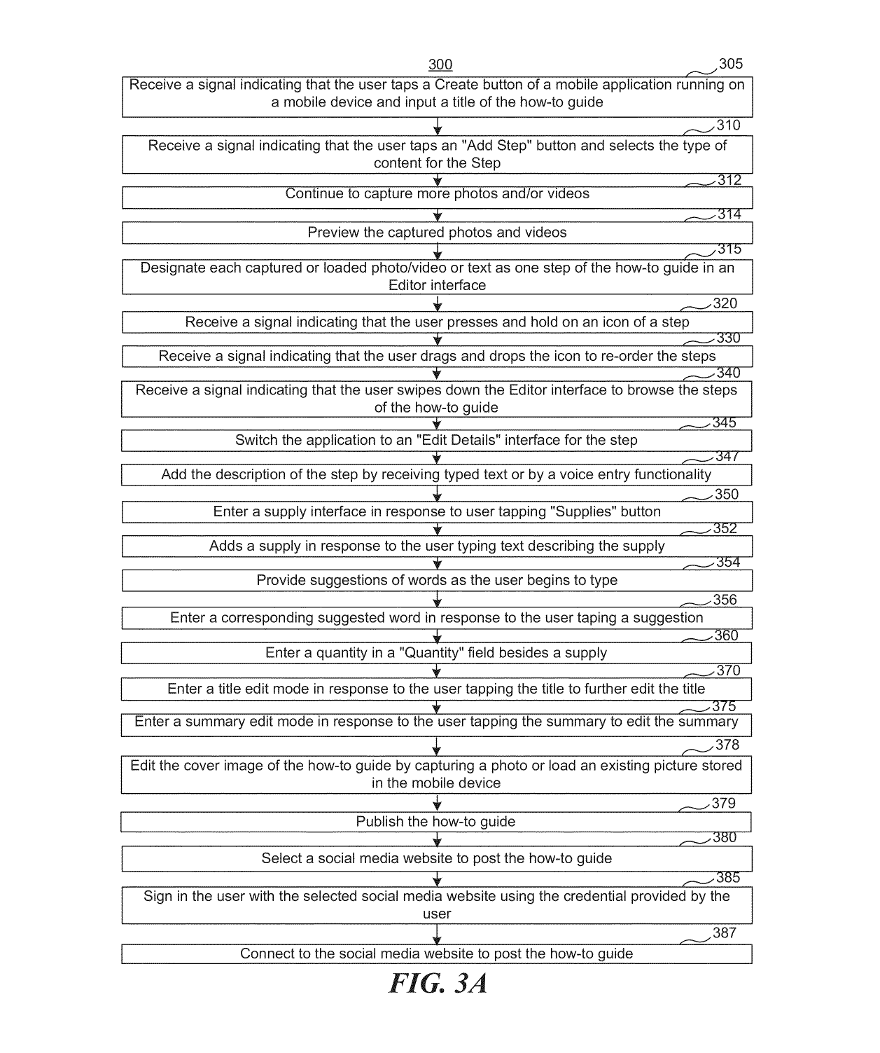

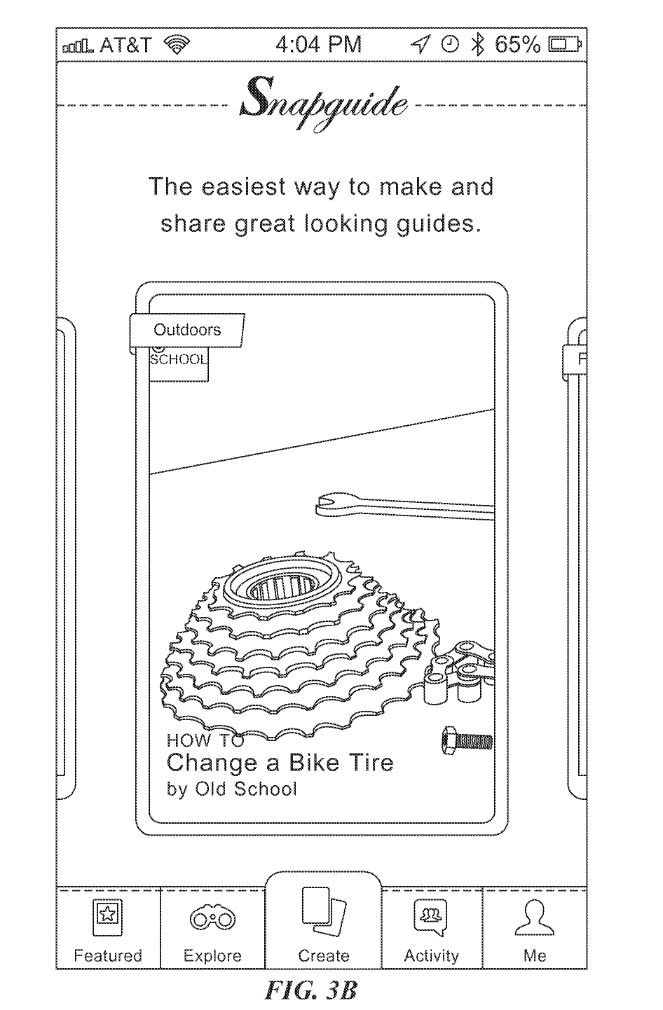

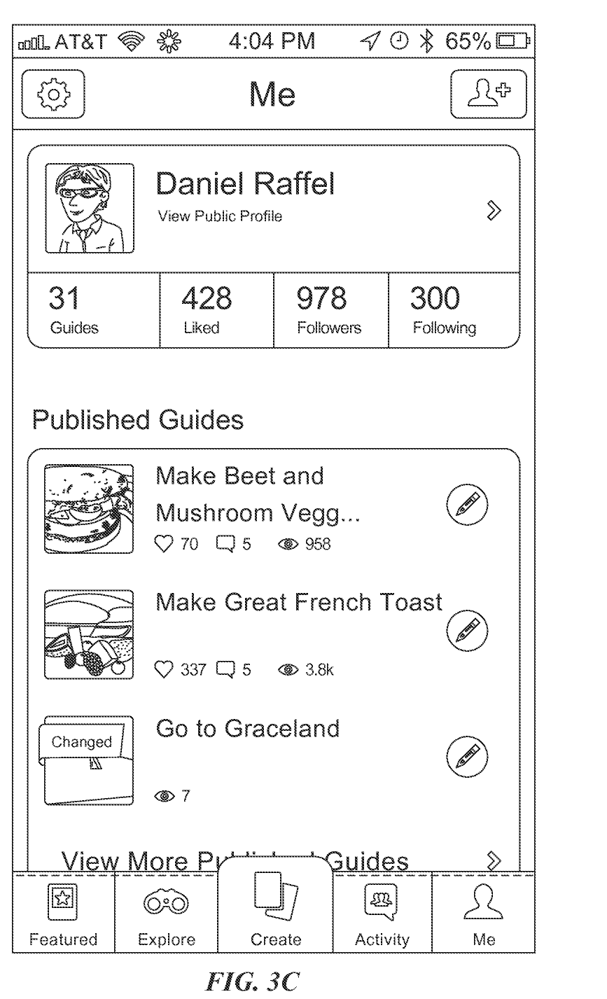

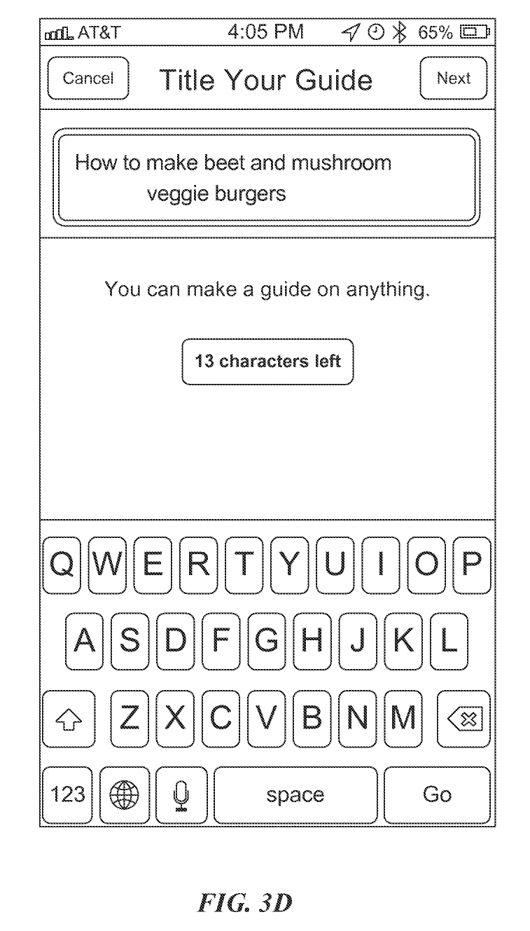

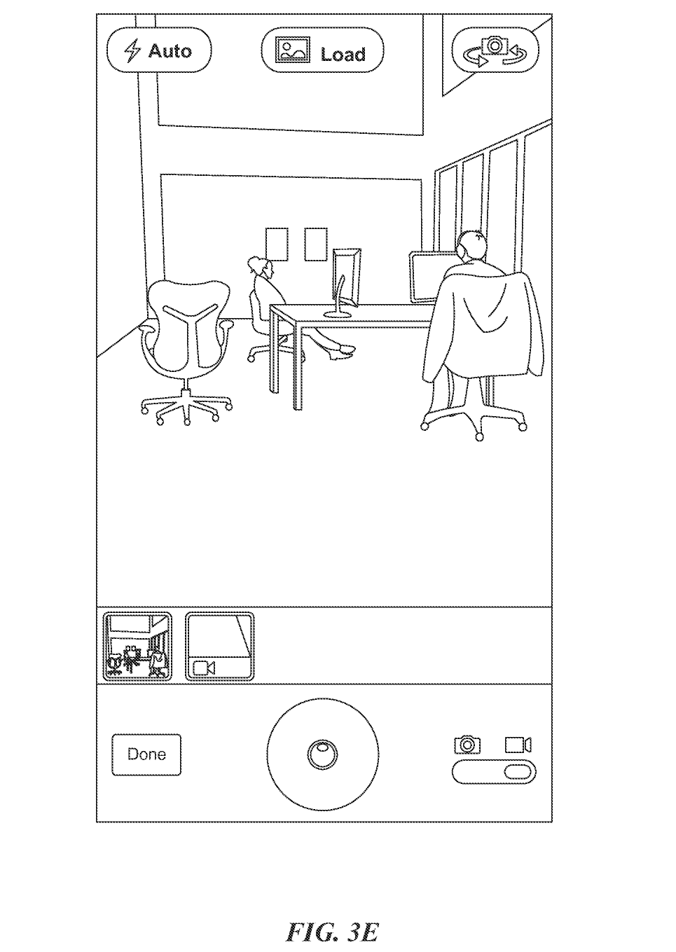

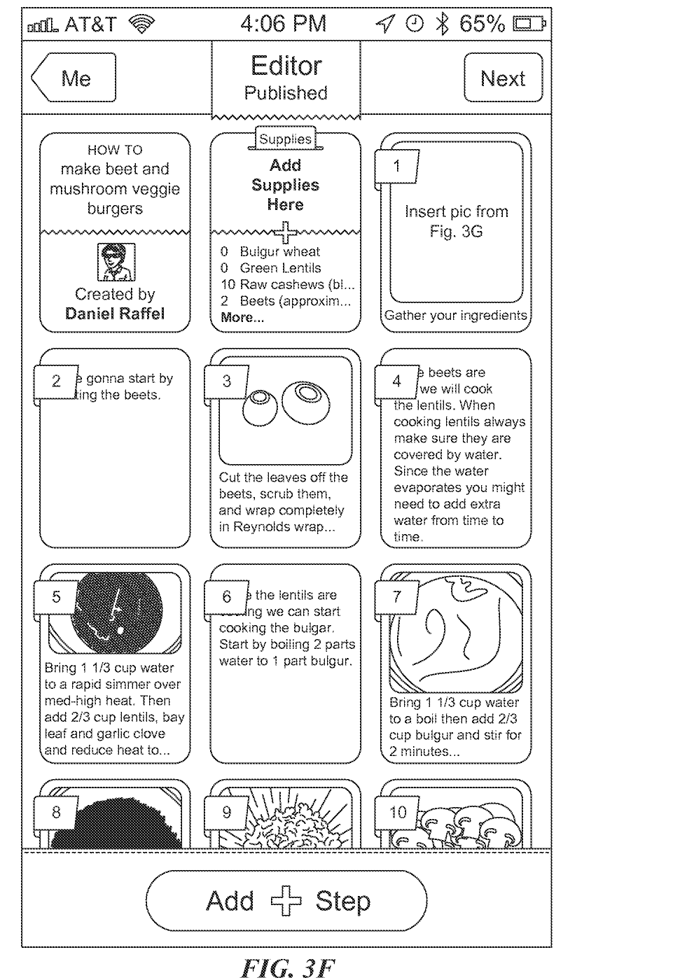

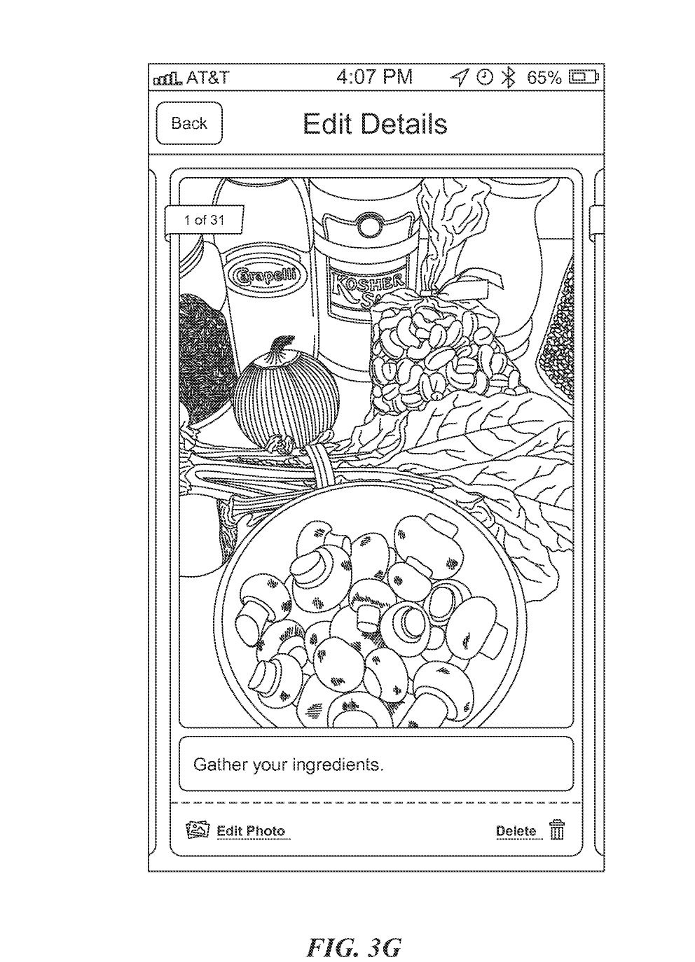

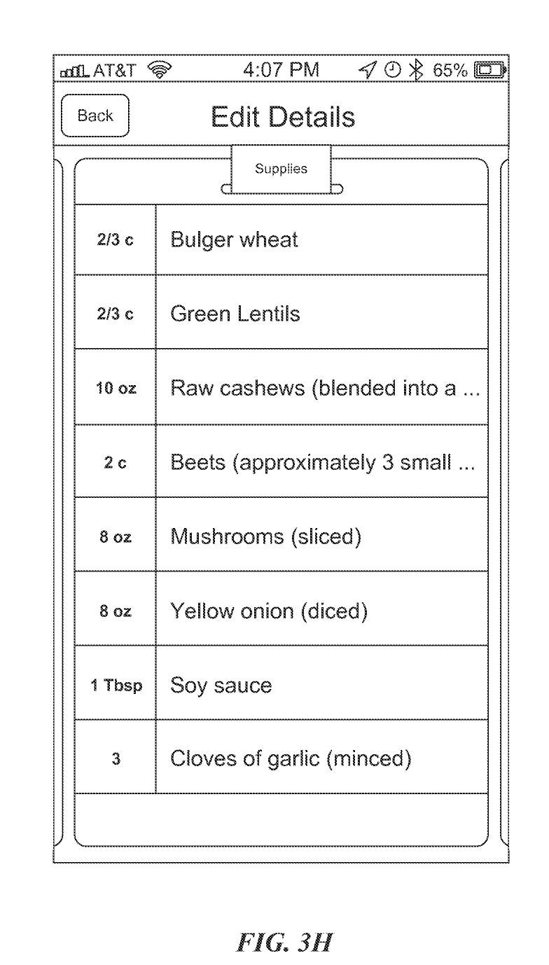

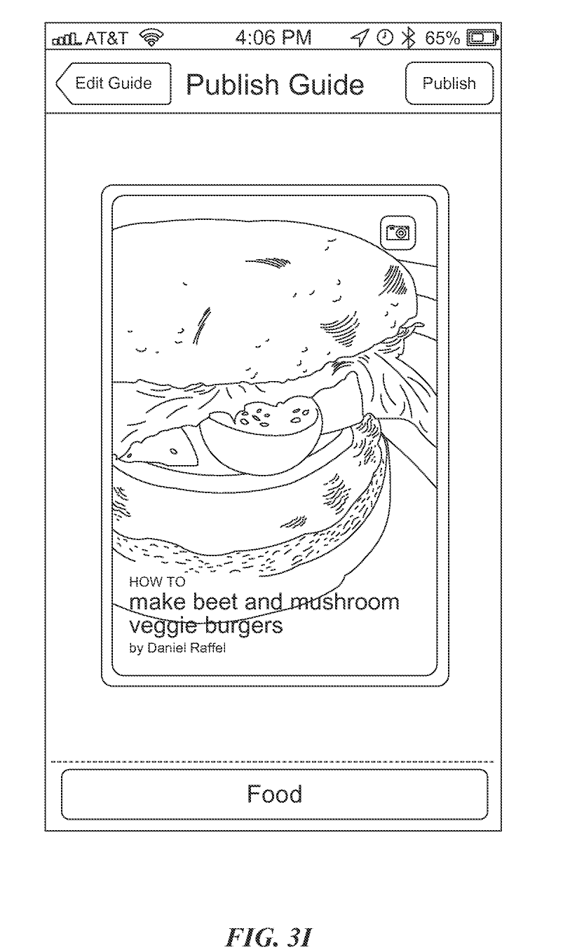

FIG. 3A illustrates an example of a computer-implemented process 300 for using a mobile application to create and publish a how-to guide. The process can be performed by a mobile application running on a mobile device of the user. For instance, FIG. 3B illustrates an example of a main user interface including tabs for various features of the mobile application. If a user click the “Me” tab shown in the FIG. 3B, the mobile application switches to a user profile interface illustrated in FIG. 3C. As shown in FIG. 3C, the user profile interface can include statistics about the user such as number of guides published, number of guides liked, number of followers, number of users following. The user profile interface also list guides that are recently published by the user and/or guides that the user are working on.

At step 305 of the process 300, the application receives a signal indicating that the user taps a Create button displayed on a graphical user interface (GUI) of the mobile application (e.g. as shown in FIG. 3B) and inputs a title of the how-to guide. FIG. 3D illustrates an example of a title interface for entering a tile for the guide. As shown in FIG. 3D, The mobile application can provide suggestions on the phrases and words for the title. A user can tap one of the suggested phrases and words to add the suggested phrase/word into the title and the user can continue typing the title.

At step 310, the application receives a signal indicating that the user taps an “Add Step” button and selects the type of content for the Step. The type of content can be photo, video, audio or text. If the user selects photo or video, the mobile application causes a camera mode of the mobile device to be activated so that the user can capture the photo or video. FIG. 3E illustrates an example of a camera interface for capturing photos and videos. The camera interface includes a switcher so that a user can switch the camera interface between a photo capture mode and a video capture mode. If the user selects audio, the mobile application causes a recorder mode of the mobile device to be activated so that the user can capture the audio. At step 312, the application continues to capture more photos and/or videos. At step 314, the application can preview the captured photos and videos.

Alternatively, the user can supply existing photos or video by tapping the “Load” button in the camera mode. Once the load media view appears, the user can select the media (e.g. photos and videos) to be included in the how-to guide.

If the user selects text type of content, the mobile application provides an interface for the user to input text.

At step 315, the mobile application designates each captured or loaded photo, video or text as one step of the how-to guide in an Editor interface. FIG. 3F illustrates an example of an Editor interface for summarizing and editing the steps of the guide. At step 320, the application receives a signal indicating that the user presses and holds on an icon of a step (e.g. an icon shown in FIG. 3F). The icon of the step shows a thumbnail image of the content of the step based on the photo, video and/or text associated with the step. At step 330, the application receives a signal indicating that the user drags and drops the icon to re-order the steps.

At step 340, the application receives a signal indicating that the user swipes down the Editor interface to browse the steps of the how-to guide. At step 345, in response to the user tapping an icon of a step, the application switches the application to an “Edit Details” interface for the step. FIG. 3G illustrates an example of an Edit Details interface for editing a step of the guide. As shown in the right bottom corner of the interface illustrated in FIG. 3G, the interface can has a link to enable the user to edit a photo or a video. At the “Edit Details” interface, the user can add more description, change photo or video, or delete the step. The user can swipe to the left or right to switch to the “Edit Details” interface for the previous or next step. At step 347, the application adds the description (also referred to as caption) of the step by receiving typed text or by a voice entry functionality. With the voice entry functionality, the mobile application can recognize the content of the voice and generate the text from the voice. The mobile application can provide more editing functionalities including resizing, rotating or cropping images, changing hue or luminosity of the images, applying filters, or editing multimedia such as trimming video and/or audio.

At step 350, the application enters a supply interface in response to user tapping “Supplies” button. FIG. 3H illustrates an example of a supplies interface for entering information of supplies for the guide. At step 352, the application adds a supply (e.g. tool, material or ingredient) in response to the user typing text describing the supply. At step 354, the mobile application provides suggestions of words as the user begins to type. At step 356, the application enters a corresponding suggested word in response to the user taping a suggestion. At step 360, the application enters a quantity in a “Quantity” field besides a supply in response to the user inputting the quantity. In one instance, the user can swipe the unit selector and the number selector to select a unit and a number for specifying the quantity.

At step 370, optionally, the application enters a title edit mode in response to the user tapping the title to further edit the title. At step 375, optionally, the application enters a summary edit mode in response to the user tapping the summary to edit the summary. At step 378, the application can further edit the cover image of the how-to guide by capturing a photo or load an existing picture stored in the mobile device.

A step 379, the application publishes the how-to guide. In one embodiment, the application publishes the how-to guide to the centralized content management server. FIG. 3I illustrates an example of a publish interface for publishing a guide. A user can review the title and the cover and the guide and then click a “Publish” button as shown in FIG. 3I to publish the guide. At step 380, the application selects a social media website, e.g. Facebook, Pinterest or Twitter to post the how-to guide in response to a user input. At step 385, the mobile application signs in the user with the selected social media website using the credential provided by the user. At step 387, the mobile application connects to the social media website to post the how-to guide. Alternatively, the mobile application can send the how-to guide to a person via an email message.

The content management system functions as a social network around people who want to learn how to make things or conduct projects. The users of the system can follow other users. The users can indicate they like certain guides that they view. The users can comment the guides. The users can further share the guides with their friends. The users can access guides related to the guide being viewed. For instance, a user can see a list of guides authored by a person who authored the guide being viewed. In another example, a user can see a list of other users who liked the guide being viewed or commented on it.

The centralized content management server synchronizes every operation of creating and editing the how-to guide. In this way, the system preserves the most recent state of the guide that is being creating on the server. More specifically, every change the user makes to a guide on the user's device is sent to the server, such as inserting a step, adding an image, deleting a step, or re-ordering steps. These changes are represented as separate transactions. A list of new transactions is kept in a certain sequential order (i.e. a log) and is sent to the server as frequently as possible so that the server has the most recent state of the guide.

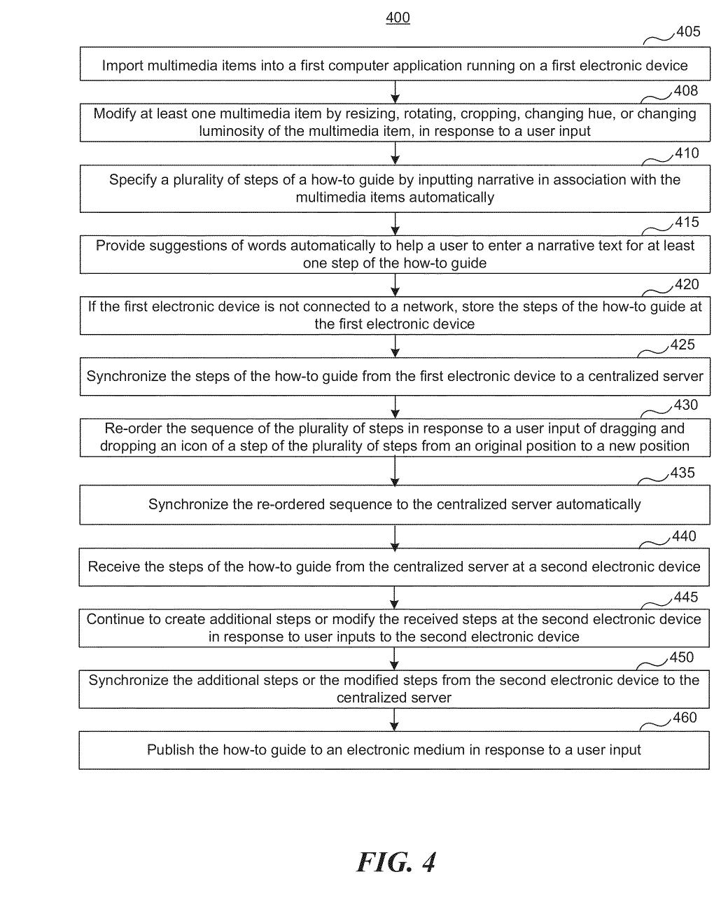

FIG. 4 illustrates an example of a computer-implemented process 400 for an algorithm for creating and publishing how-to guides. At step 405 of the process 400, a first computer application running on a first electronic device imports a plurality of multimedia items into the first computer application. The multimedia items can include photos, audios, and videos. The multimedia items can be captured by a camera component of the first electronic device for example, or can be existing photos or videos stored in the first electronic device and loaded into the first computer application. Optionally at step 408, the first computer application modifies at least one multimedia item of the plurality of multimedia items by resizing, rotating, cropping, changing hue, or changing luminosity of the multimedia item, in response to a user input.

At step 410, the first computer application specifies a plurality of steps of a how-to guide by inputting narrative in association with the multimedia items automatically, without user intervention. At step 415, the first computer application provides suggestions of words automatically to help a user to enter a narrative text for at least one step of the how-to guide.

At step 420, if the first electronic device is not connected to a network, the first computer application stores the steps of the how-to guide at the first electronic device. At step 425, the first computer application synchronizes the steps of the how-to guide from the first electronic device to a centralized server when the first electronic device is connected to the centralized server. In one embodiment, the first computer application sends data indicating the steps of the how-to guide from the first electronic device to the centralized server to cause a synchronization of a version of the how-to guide on the first electronic device with a version of the how-to guide on the centralized server.

At step 430, the first computer application re-orders the sequence of the plurality of steps in response to a user input of dragging and dropping an icon of a step of the plurality of steps from an original position to a new position. At step 435, the first computer application synchronizes the re-ordered sequence of the steps to the centralized server automatically.

At step 440, a second computer application running on a second electronic device receives the steps of the how-to guide from the centralized server. The second computer application can also receive metadata of the how-to guide, e.g. the title of the how-to guide. At step 445, the second computer application continues to create additional steps or modify the received steps in response to user inputs to the second electronic device. At step 450, the second computer application synchronizes the additional steps or the modified steps from the second electronic device to the centralized server automatically.

At step 460, the first computer application publishes the how-to guide to an electronic medium in response to a user input. The electronic medium can be a post in a social networking system or an email message.

The centralized server can perform as a website host by maintaining a website for searching and presenting how-to guides. The centralized server can provide a list of how-to guides, wherein the list of how-to guides is generated at the centralized server by searching a database of how-to guides with criteria provided by a user.

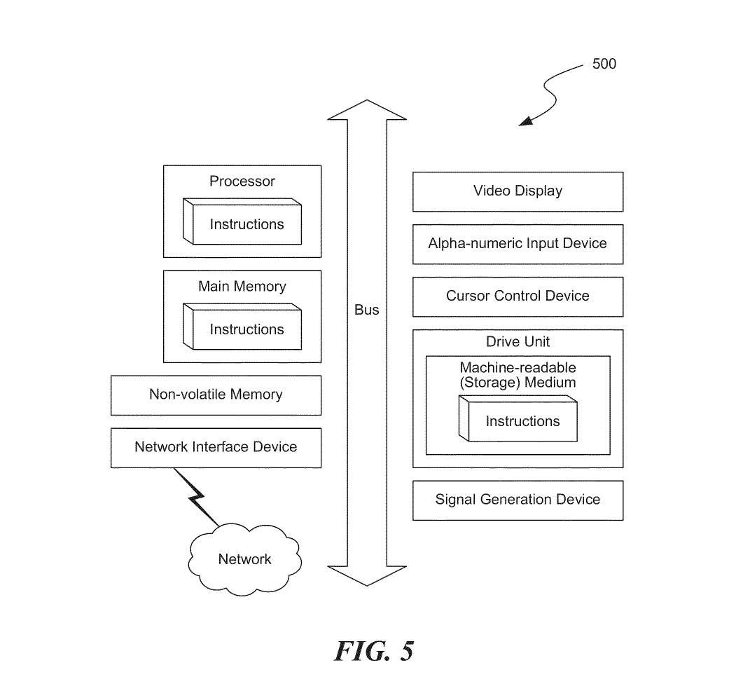

FIG. 5 shows a diagrammatic representation of a machine in the example form of a computer system 500 within which a set of instructions, for causing the machine to perform any one or more of the methodologies discussed herein, may be executed.

In alternative embodiments, the machine operates as a standalone device or may be connected (e.g., networked) to other machines. In a networked deployment, the machine may operate in the capacity of a server or a client machine in a client-server network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a web appliance, a network router, switch or bridge, or any machine capable of executing a set of instructions (sequential or otherwise) that specify actions to be taken by that machine.

While the machine-readable (storage) medium is shown in an exemplary embodiment to be a single medium, the term “machine-readable (storage) medium” should be taken to include a single medium or multiple media (e.g., a centralized or distributed database, and/or associated caches and servers) that store the one or more sets of instructions. The term “machine-readable medium” or “machine readable storage medium” shall also be taken to include any medium that is capable of storing, encoding or carrying a set of instructions for execution by the machine and that cause the machine to perform any one or more of the methodologies of the present invention.

In general, the routines executed to implement the embodiments of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

Further examples of machine or computer-readable media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

In addition to the above mentioned examples, various other modifications and alterations of the invention may be made without departing from the invention. Accordingly, the above disclosure is not to be considered as limiting and the appended claims are to be interpreted as encompassing the true spirit and the entire scope of the invention.

1. A method comprising:
importing a plurality of multimedia items into a first processing device;
specifying, at the first processing device, a plurality of steps of a multimedia instructional presentation by inputting narrative in association with the multimedia items; and
causing the multimedia instructional presentation to be published onto an electronic medium.

2. The method of claim 1, further comprising:
sending data indicating the steps of the multimedia instructional presentation from the first processing device to a server to cause a synchronization of a version of the multimedia instructional presentation on the first processing device with a version of the multimedia instructional presentation on the server.

3. The method of claim 2, wherein said causing comprises:
causing the multimedia instructional presentation to be published by the server onto an electronic medium.

4. The method of claim 2, further comprising:
receiving the data indicating the steps of the multimedia instructional presentation and metadata of the multimedia instructional presentation at a second processing device from the server; and
enabling a user to create additional steps or modify the steps of the multimedia instructional presentation at the second processing device.

5. The method of claim 2, further comprising:
sending data indicating the additional steps or the modified steps to the remote server to cause a synchronization of a version of the multimedia instructional presentation on the second processing device with the version of the multimedia instructional presentation on the server.

6. The method of claim 2, wherein said sending comprises:
when the first processing device is not connected to a network, storing the steps of the multimedia instructional presentation in the first processing device;
when the first processing device is connected to a network, sending data indicating the steps of the multimedia instructional presentation from the first processing device to the server to cause a synchronization of a version of the multimedia instructional presentation on the first processing device with a version of the multimedia instructional presentation on the server.

7. The method of claim 2, further comprising:
updating a second version of the multimedia instructional presentation on a second processing device simultaneously when a first version of the multimedia instructional presentation is being updated on the first electronic device; and
sending data indicating the steps of the second version and the first version of the multimedia instructional presentation to the server to cause a synchronization of the second version and the first version of the multimedia instructional presentation with a version of the multimedia instructional presentation on the server.

8. The method of claim 1, wherein the electronic medium comprises a post in a social networking system.

9. The method of claim 1, wherein the electronic medium comprises an email message.

10. The method of claim 1, wherein the multimedia items include photos, audios, or videos.

11. The method of claim 1, wherein said importing comprises:
capturing a photo or a video using a camera component of the first processing device, or
capturing an audio using a recorder component of the first processing device.

12. The method of claim 1, wherein said importing comprises:
loading a photo or a video stored in the first processing device.

13. The method of claim 1, further comprising:
presenting automatic suggestions of words for the narrative.

14. The method of claim 2, further comprising:
retrieving a list of multimedia instructional presentations from the server, wherein the list of multimedia instructional presentations is generated at the server by searching a database of multimedia instructional presentations with criteria provided by a user.

15. The method of claim 2, further comprising:
re-ordering the sequence of the plurality of steps by enabling a user to drag-and-drop an icon of a step of the plurality of steps from an original position to a new position; and
sending data indicating the sequence of the steps of the multimedia instructional presentation from the first processing device to the server to cause a synchronization of the version of the multimedia instructional presentation on the first processing device with the version of the multimedia instructional presentation on the server.

16. The method of claim 1, further comprising:
enabling a user to modify a multimedia item of the plurality of multimedia items by resizing, rotating, cropping, changing hue, changing luminosity, applying filters, or trimming multimedia clips.

17. A processing device comprising:
a processor;
a camera;
a network interface via which the processing device can communicate with a server via a network;
a memory storing instructions that, when executed by the processor, cause the processing device to perform a process including:
importing a plurality of multimedia items into the processing device;
specifying, at the processing device, a plurality of steps of a multimedia instructional presentation by inputting narrative in association with the multimedia items, wherein the narrative includes text or audio; and
causing the multimedia instructional presentation to be published onto an electronic medium.

18. The processing device of claim 17, wherein the process further includes:
sending data indicating the steps of the multimedia instructional presentation from the first processing device to a server to cause a synchronization of a version of the multimedia instructional presentation on the first processing device with a version of the multimedia instructional presentation on the server, so that another processing device can continue updating the multimedia instructional presentation by retrieving the version of the multimedia instructional presentation on the server.

19. The computer processing device of claim 17, wherein at least one of the plurality of multimedia items is a photo or video stored in the processing device.

20. The processing device of claim 17, further comprising:
an input component configured to enable a user to drag and drop an icon of a step of the plurality of steps to re-order a sequence of the plurality of steps.

21. A method comprising:
receiving, at a server from a first electronic device, an update log for a multimedia instructional guide, the update log including a sequential list of updates to the multimedia instructional guide, the update log having been created by the first electronic device during an interactive process of creating the multimedia instructional guide on the electronic device;
storing the update log of the multimedia instructional guide in a database by the server; and
sending, from the server to a second electronic device, the update log of the multimedia instructional guide to enable a process of creating or updating the multimedia instructional guide to be continued at the second electronic device.

22. The method of claim 21, further comprising:
hosting a website at the server; and
generating a presentation of the multimedia instructional guide for the website when a request for the multimedia instructional guide is received by the server.
